(19) United States
(12) Patent Application Publication
(10) Pub. No.: US 2005/0205143 A1
(43) Pub. Date: Sep. 22, 2005

(54) Bypass water valve

(76) Inventor: Christopher T. Hughes, Columbus, OH (US)

Correspondence Address: Jerry K. Mueller, Jr.;Mueller and Smith, LPA, 7700 Rivers Edge Drive, Columbus, OH, 43235, US

(21) Appl. No.: 10/805,566

(22) Filed: Mar. 19, 2004

(51) Int. Cl. F16K 11/07

(52) U.S. Cl. 137/625.29

(57) ABSTRACT

A single 180-degree turn of a knob moves the valve between sending water through the softener/filter unit and bypassing it. The knob is attached to a geared shaft. The geared shaft mates with a geared piston. This piston contains 2 cylindrical sealing surfaces riding axially in an inner bore connected to the in and out ports for the plumbing. In service, one of the sealing surfaces seals in the middle of the inner bore, forcing flow down into the unit. Turning the bypass knob translates the piston so that one sealing surface seals one end of the inner bore while the other sealing surface seals the other end. This blocks flow from entering the unit and provides a flow path directly from the in port to the out port.

### CROSS-REFERENCE TO RELATED APPLICATIONS

None.

### STATEMENT REGARDING FEDERALLY SPONSORED RESEARCH

Not applicable.

### BACKGROUND OF THE INVENTION

The present invention relates to water treatment systems, sometimes commonly known as water softening systems, and more particularly to a unique bypass water valve for use with such systems.

Resin-type ion exchange devices have many uses, such as the softening of water. As the water to be processed is passed through the resin-filled tank, ions in the fluid to be processed, e.g., calcium, are exchanged with ions found in the resin, e.g., sodium, thereby removing objectionable ions found in the water. During this ion exchange process, the ability of the resin to exchange ions gradually is reduced. That is, the resin bed becomes exhausted and, thereafter, water will flow therethrough in unprocessed form.

The capacity of the ion exchange resin bed can be determined from the volume of resin used and the particular type of resin. The concentration of contaminant(s) in the water to be processed can be determined, at least on an average basis. Thus, the volume of water that can be processed by a particular water treatment unit is known. Once that capacity of water has been treated, the bed must be regenerated.

Regeneration of the ion exchange resins typically involves chemically replacing the objectionable ions from the resin with less objectionable ions, e.g., replacing calcium with sodium ions. This regeneration process requires the suspension of the treatment process; thus, necessitating the water to bypass the ion exchange resin tank. At the same time as the ion exchange resin is regenerated, the bed can be backwashed in order to remove trapped particulate matter, the resin tank can be rinsed to remove objectionable soluble materials, an application of sterilization agent to prevent bacterial growth can be accomplished, etc. All of these operations are known in the art.

Water flow into the unit is controlled by a bypass water valve, which as its name implies, must have the ability to permit the service water to bypass the water softening unit and pass directly into the building's water piping and manually on an as needed basis. The main reasons for bypassing the unit is for servicing the unit without cutting off the water supply to the building, or to permit large quantities of untreated water to be used, for example, for watering laws, washing cars, or the like.

Heretofore, U.S. Pat. No. 4,621,679 proposes a water system valve comprising a valve housing 20, supply and return lines, a pinion gear 75, a rack 81, an actuating arm 77, and a valve element 45 (FIG. 2). U.S. Pat. No. 5,309,934 proposes a balanced piston valve including a rack and pinion (144, 146, 145), a piston-like member 130, and a knob 104 (FIGS. 6, 7). U.S. Pat. No. 5,421,358 proposes a fluid valve mechanism including a piston-like valve member 130, rack and pinion (144, 146, 145) and a knob 104 (FIGS. 7, 8). U.S. Pat. No. 3,847,210 proposes a fluid flow apparatus having a damper frame forming flow paths for bypass air including pinion gears (46, 48, 50) and rack segments (52, 54, and 56) (FIG. 3).

It is an improved bypass water valve that the present invention is directed.

### BRIEF SUMMARY OF THE INVENTION

The invention is a compact, lightweight, and easy-to-use bypass valve that is unique is its gear-driven, single turn operation. It is unlike push-pull type or double turn bypass valves currently available. A single 180-degree turn of one knob moves the valve between sending water through the softener/filter unit and bypassing it. The knob is attached to a geared shaft. The geared shaft mates with a geared piston. This piston contains 2 cylindrical sealing surfaces riding axially in an inner bore connected to the in and out ports for the plumbing. In service, one of the sealing surfaces seals in the middle of the inner bore, forcing flow down into the unit. Turning the bypass knob translates the piston so that one sealing surface seals one end of the inner bore while the other sealing surface seals the other end. This blocks flow from entering the unit and provides a flow path directly from the in port to the out port.

In detail the bypass water valve composed of a housing having a service water inlet and service water outlet, a tank inlet and a tank outlet, and an inner bore in flow communication with the service water inlet and service water outlet and with said tank inlet and tank outlet. A geared piston is slidably disposed in the housing inner bore and has a pair of ends that have sealing surfaces. A geared shaft knob is mated with the geared piston to urge the piston to slidably move axially within the housing inner bore by rotation of the knob. In a service mode, one of the sealing surfaces seals in the middle of the inner bore forces flow down into the unit. A bypass mode is achieved by rotation of the knob to translate the piston axially in the housing inner bore so that one sealing surface seals one end of the housing inner bore while the other sealing surface seals the other end of the housing inner bore, thereby blocking flow to the tank inlet and from the tank outlet, and providing a flow path directly from the water inlet to the water outlet.

### BRIEF DESCRIPTION OF THE DRAWINGS

For a fuller understanding of the nature and advantages of the present invention, reference should be had to the following detailed description taken in connection with the accompanying drawings, in which:

FIG. 1 top plan view of the bypass water valve;

FIG. 2 is a side view of the bypass water valve of FIG. 1;

FIG. 3 is a cross-sectional elevational view taken along line 1-1 of FIG. 3 of the bypass water valve showing the flow of water when the valve is in the operation mode;

FIG. 4 is a cross-sectional elevational view taken along line 1-1 of FIG. 3 of the bypass water valve showing the flow of water when the valve is in the bypass mode; and FIG. 5 is a perspective view of the piston of the bypass water valve of FIG. 1.

The drawings will be described in detail below.

### DETAILED DESCRIPTION OF THE INVENTION

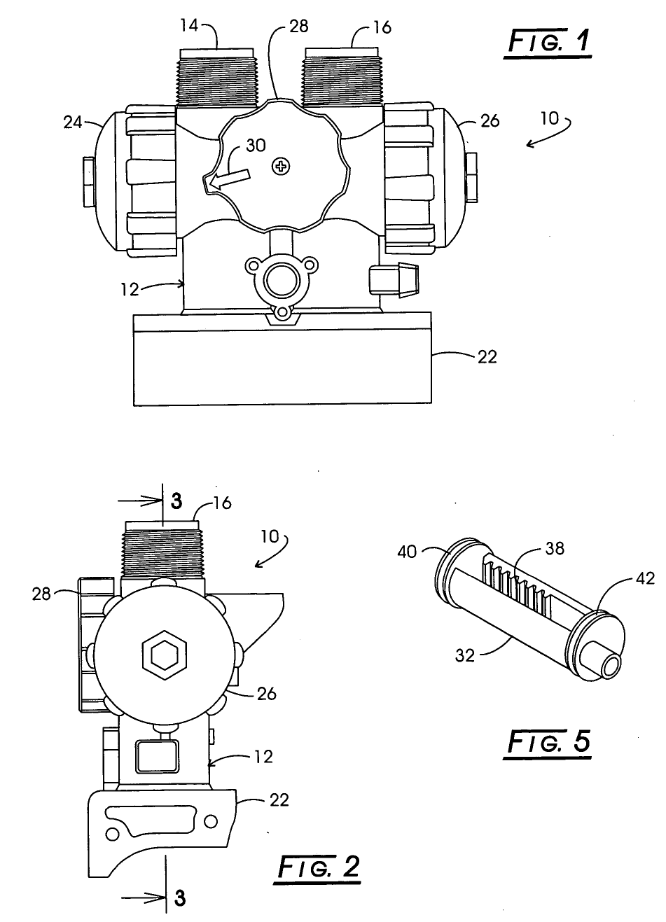

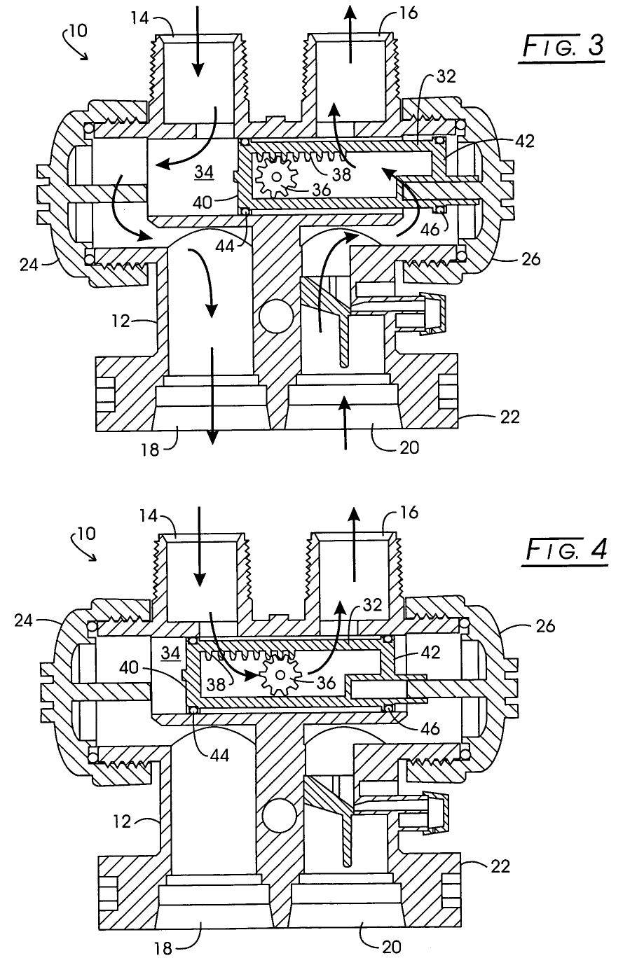

Referring initially to FIGS. 1 and 2, a bypass water valve, 10, has a housing, 12, connectable to a water softener, water filter, water reverse osmosis unit, or other water-processing unit (not shown in the drawings but often referred to herein as “unit”) by an exteriorly threaded service water inlet, 14, and an exteriorly threaded service water outlet, 16. The exterior threads are sized for attachment to building plumbing for establishing a watertight connection. Flow from service water inlet 14 through bypass water valve 10 enters the unit through a service water inlet, 18, and is withdrawn from the unit through a service water outlet, 20, (see FIG. 3) which are surmounted by a rectangular frame, 22, that is designed to mate with the unit.

Bypass water valve 10 also has a pair of interiorly threaded caps, 24 and 26, which provide access to the interior of bypass water valve 10, which interior will described in detail below in connection with FIGS. 3 and 4. Also seen in FIGS. 1 and 2 and carried by bypass water valve 10 is a geared shaft knob, 28, whose connection and function also will be described in detail below in connection with FIGS. 3 and 4. Knob 28 is seen to have a radially-disposed arrow, 30, that alerts the user to the position of bypass water valve 10 as being in a “bypass” position (as shown in FIG. 1) or in a “service” position which would occur by rotating knob 28 one-half of a turn (180°) in a clockwise direction. In fact, housing 12 can have the words “bypass” and “service” applied to alert the user.

FIG. 3 shows know 28 rotated to the “service” position. In this position, water flows through bypass water valve 10 and into the unit for treatment of the water and then out of the unit through bypass water valve 10 and back into the plumbing of the building where bypass water valve 10 is located. For this service position, a geared piston, 32, is located in an inner bore, 34, located within housing 12. Piston 32 can be translated axially (along the axis of bore 34) by rotation of geared knob 28, because knob 28 is affixed to gear, 36, which mates with gear teeth, 38, disposed along the interior of piston 32.

Geared piston 32 has a pair of ends, 40 and 42, which are sealed against bore 34 by sealing rings, 44 and 46, respectively. Other sealing mechanisms can, of course, be provided in conventional fashion, as is necessary, desirable, or convenient. In the service position as shown in FIG. 3, water enters bypass water valve 10 via service water inlet 14 and follows the flow path of arrows until it exits bypass water valve 10 via tank inlet 18. Water in the unit, then enters bypass water valve 10 via tank outlet 20 and follows the flow path of arrows until it exits bypass water valve 10 via service water outlet 16. Seal 40 seals the center of bore 34 enabling the flow as described.

In the bypass position as shown in FIG. 4, water enters bypass water valve 10 via service water inlet 14 and follows the flow path of arrows until it exits bypass water valve 10 via service water outlet 16. This flow path is possible because piston 40 has been translated to the bypass position by geared knob 28, wherein gear 36 rotates and translate piston 40 to the left via piston gear teeth 38. In this translated position, piston sealing ring 44 and piston sealing ring 46 seal the interior of bore 34 and in particular establish a direct flow path from service water inlet 14 to service water outlet 16 following the arrows in FIG. 4. In this bypass position, the unit is taken out of active service for regeneration, repair, maintenance, or other activity.

Piston 32 is shown in greater detail in FIG. 5. Piston 32 carries teeth 38 along the interior of a cavity in piston 32. Sealing rings 40 and 42 also can be seen. Other sealing mechanisms and designs for gear 38 can be utilized, as the skilled artisan will appreciate.

Bypass water valve 10 advantageously will be manufactured from plastic, although metal, ceramic, laminate, or other material could be used. Injection molding of bypass water valve 10 and its parts is a convenient method of manufacture.

While the invention has been described with reference to a preferred embodiment, those skilled in the art will understand that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In this application all units are in the metric system and all amounts and percentages are by weight, unless otherwise expressly indicated. Also, all citations referred herein are expressly incorporated herein by reference.

1. A bypass water valve, which comprises:
(a) a housing having a service water inlet and service water outlet, a tank inlet and a tank outlet, and an inner bore in flow communication with said service water inlet, said service water outlet, said tank inlet, and said tank outlet;
(b) a geared piston slidably disposed in said housing inner bore and having a pair of ends that have sealing surfaces;
(c) a geared knob having a hand actuatable knob and carrying a gear that mates with said geared piston to urge said piston to slidably move axially within said housing inner bore by rotation of said knob;
wherein in a service mode one of the sealing surfaces seals in the middle of the inner bore thereby forcing flow down into the unit; wherein in a bypass mode achieved by rotation of said geared knob for translating the piston axially in said housing inner bore so that one sealing surface seals one end of the housing inner bore while the other sealing surfaces seals the other end of the housing inner bore thereby blocking flow to the tank inlet and from the tank outlet, and providing a flow path directly from the water inlet to the water outlet.

2. The bypass water valve of claim 1, wherein said knob is hand actuatable.

3. The bypass water valve of claim 1, wherein rotation of said knob 180° urges said piston from a service mode to a bypass mode and vice versa.
